(19) United States
(12) Patent Application Publication
(10) Pub. No.: US 2020/0049954 A1
(43) Pub. Date: Feb. 13, 2020

(54) LENS MODULE

(71) Applicant: AAC Technologies Pte. Ltd., Singapore City (SG)

(72) Inventor: Chuandong Wei, Shenzhen (CN)

(21) Appl. No.: 16/529,766

(22) Filed: Aug. 1, 2019

(30) Foreign Application Priority Data
Aug. 10, 2018 (CN) 201821302242.6

(51) Int. Cl. G02B 13/00; G02B 7/02

(52) U.S. Cl. CPC G02B 13/0015; G02B 7/021

(57) ABSTRACT

The present disclosure provides a lens module, including a lens barrel, a lens group disposed in the lens barrel, and a pressing ring. The lens module includes a lens, the lens includes an optical portion and a bearing portion disposed around the optical portion, the bearing portion includes an object side facing a side of an object, an image side disposed opposite to the object side, and a lateral surface connecting the object side and the image side, the image side is provided with a first concave part, the first concave part and the inner-side wall of the second barrel wall jointly form a first adhesive accommodating slot for accommodating adhesive. Compared with related technologies, the lens module provided by the present disclosure has high structural strength, a stable connection, and high reliability.

### TECHNICAL FIELD

The present disclosure relates to the field of imaging technologies, more particular to a lens module.

### BACKGROUND

With continuous development of technologies, portable electronic devices continue to develop towards intelligence and miniaturization. In addition to digital cameras, portable electronic devices such as tablet computers and mobile phones and the like are equipped with lens modules with a shooting performance, and shooting requirements for the lens modules are also increasingly high.

In related technologies, a lens module structure of a camera in an electronic device is usually composed of an aspheric lens and an external fixed mechanical part, and then a whole lens module is composed of a light-shielding sheet, a light-shielding plate, a connecting portion, and a plug. The whole lens module structural member is fixed by dispensing adhesive at the plug. In this manner, an anchoring force for fix the lens module is insufficient, and lenses are easily loosened, resulting in imaging instability.

Therefore, a new lens module is necessary to be provided to resolve the foregoing technical problem.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following descriptions are merely some embodiments of the present disclosure, and a person of ordinary skill in the art may still derive other accompanying drawings from these accompanying drawings without creative efforts.

FIG. 1 is a stereogram of a lens module according to the present disclosure;

FIG. 2 is an exploded view of the lens module according to the present disclosure;

FIG. 3 is a sectional view along an A-A line in FIG. 1; and

FIG. 4 is an enlarged view of an area B in FIG. 3.

### DETAILED DESCRIPTION

The following clearly and completely the technical solutions in embodiments of the present disclosure with reference to the accompanying drawings of the embodiments of the present disclosure. Apparently, the embodiments described are merely some but not all of the embodiments of the present disclosure. All other embodiments obtained by a person of ordinary skilled in the art based on the embodiments of the present disclosure without creative efforts shall fall within the protection scope of the disclosure.

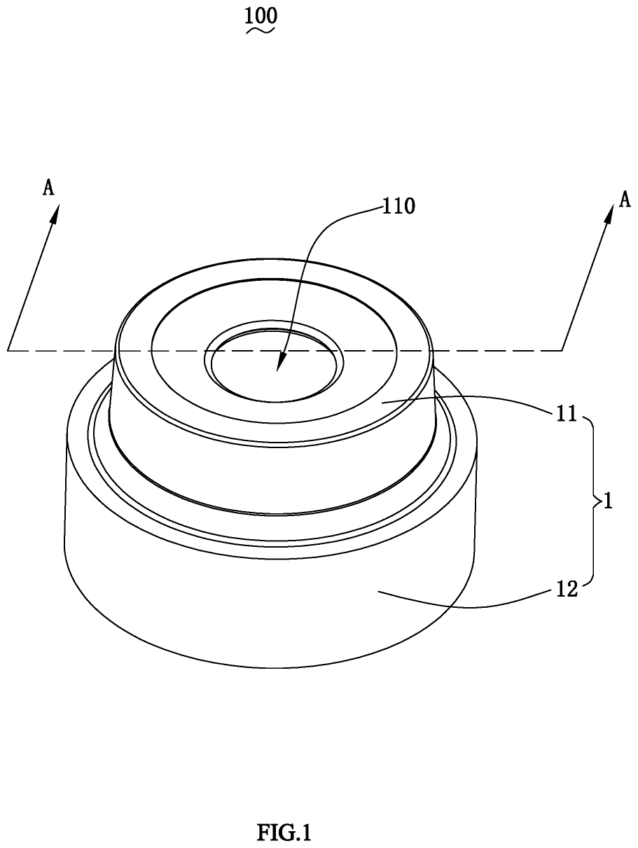

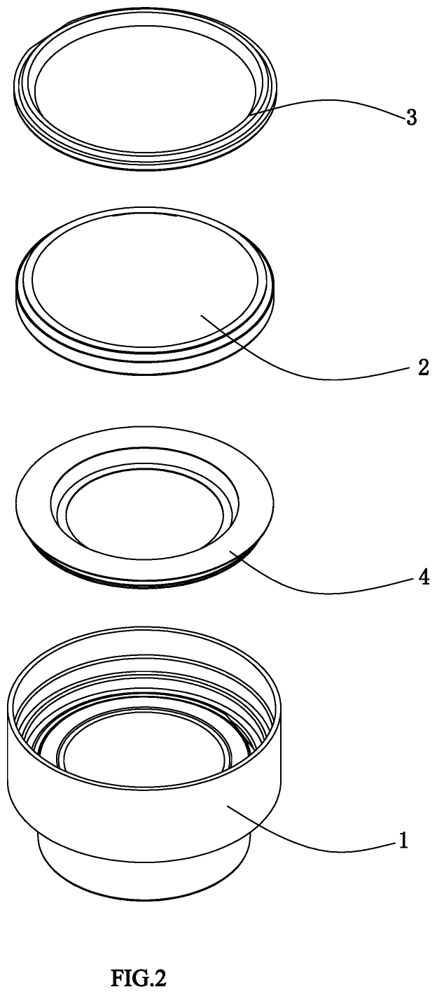

Referring to FIG. 1 and FIG. 2, a lens module 100 configured for optical imaging includes a lens barrel 1, a lens group 2, a pressing ring 3, and a light-shielding member 4.

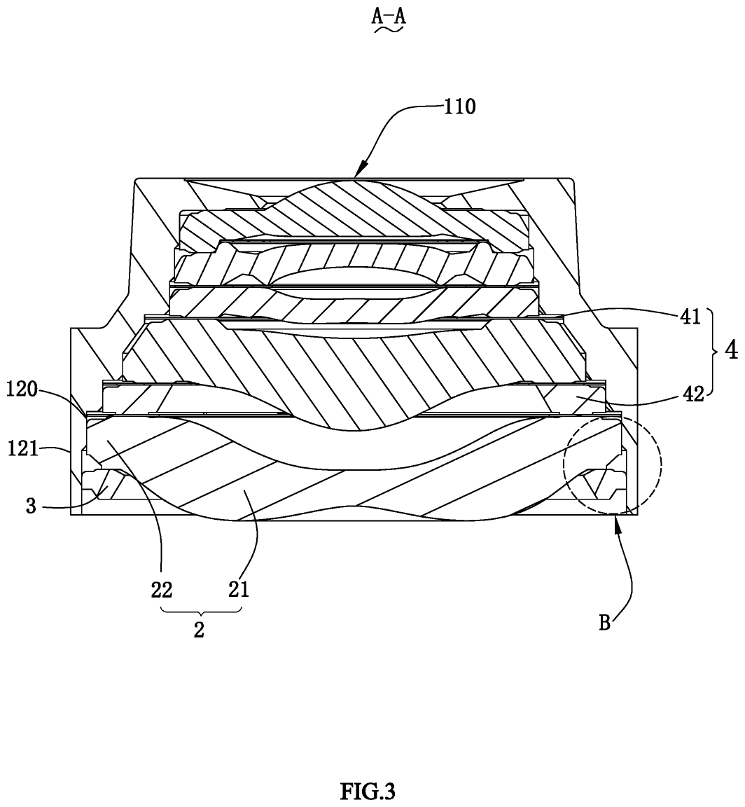

Referring to FIG. 2 and FIG. 3, the lens barrel 1 includes a first barrel wall 11 provided with an optical aperture 110 and a second barrel wall 12 bending and extending from the first barrel wall 11, the second barrel wall 12 includes an inner-side wall 120 near an optical axis and an outer-side wall 121 disposed opposite to the inner-side wall 120. The lens barrel 1 is configured to provide a mounting position for the lens group 2, the inner-side wall 120 includes: a first abutting surface 1201 abutting against the lens group 2, an extend surface 1202 bending and extending from the first abutting surface 1201 to a direction away from the optical axis, and a second abutting surface 1203 connected to the extend surface 1202.

The lens group includes a plurality of lenses 20, the plurality of lenses 20 are configured from a side of an object to an image side to form the lenses group 2, the object side is a side that is of the optical aperture 110 and that aligns with the object, and the image side is a side opposite to the side of the object. The lenses 20 include an optical portion 21 and a bearing portion 22 disposed around the optical portion 21, the optical portion 21 is configured for optical imaging, and the bearing portion 22 is configured to fix the lenses 20 to the lens barrel 1.

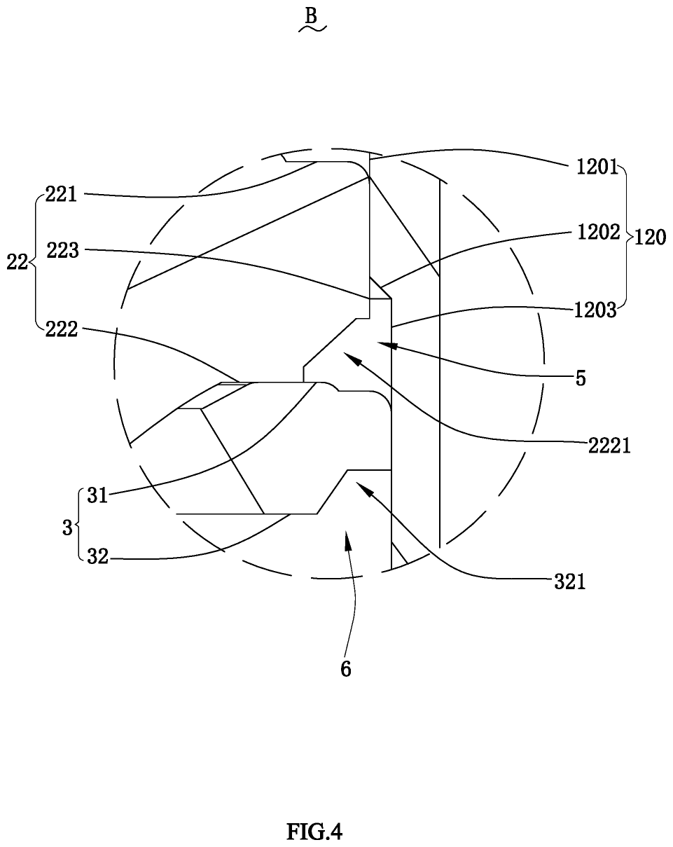

Referring to FIG. 3 and FIG. 4, the bearing portion 22 includes an object side 221 facing the side of the object, an image side 222 disposed opposite to the object side 221, and a lateral surface 223 connecting the object side 221 and the image side 222. The lateral surface 223 abuts against the first abutting surface 1201, the image side 222 is provided with a first concave part 2221 concaved from the image side 222 to the object side 221 and runs through the lateral surface 223. The first concave part 2221 and the inner-side wall 120 of the second barrel wall 12 jointly form a first adhesive accommodating slot 5 for accommodating adhesive. In a preferred implementation of the present disclosure, the first adhesive accommodating slot 5 is a continuous annular structure.

The pressing ring 3 is disposed at one end of the image side of the lens module 100 and fixed to the second abutting surface 1203, and is configured to limit and fix the lens group 2, so that the lenses in the lens group 2 are closely arranged and a structure of the lens group 2 is stable. The pressing ring 3 includes a first surface 31 abutting against the image side 222 and a second surface 32 disposed opposite to the first surface 31, and the pressing ring 3 is provided with a second concave part 321 concaved from the second surface 32 to the first surface 31, the second concave part 321 and the inner-side wall 120 of the second barrel wall 12 jointly form a second adhesive accommodating slot 6 for accommodating adhesive. In a preferred implementation of the present disclosure, the second adhesive accommodating slot 6 is a continuous annular structure.

The first adhesive accommodating slot 5 and the second adhesive accommodating slot 6 are disposed. During assembling, first, the lens group 2 is mounted and fixed at the first adhesive accommodating slot 5 by dispensing adhesive, then the pressing ring 3 is abutted against the image side of the lens group 2, and the lens group 2 is tightly pressed, so that the lenses in the lens group 2 are closely arranged. Finally, the lens group 2 is fixed at the second adhesive accommodating slot 6 by dispensing adhesive, so that an adhesive area of the adhesive is increased. Therefore, stability and reliability of the lens module 100 are improved.

The light-shielding member 4 is a hollow annular structure, and the light-shielding member 4 is bonded to the lens 2. The light-shielding member 4 includes a light-shielding sheet 41 and a light-shielding plate 42, and the light-shielding member 4 is configured to shield stray light, so that imaging quality of the lens module 100 is improved.

Compared with related technologies, in the lens module of the present disclosure, the first concave part and the inner-side wall of the second barrel wall jointly form the first adhesive accommodating slot for accommodating adhesive, the second concave part and the inner-side wall of the second barrel wall jointly form the second adhesive accommodating slot for accommodating adhesive, and the first adhesive accommodating slot and the second adhesive accommodating slot form a dual dispensing structure, thereby increasing an anchoring force for fixing the lens module, and improving reliability of the lens module.

The foregoing descriptions are merely implementations of the present disclosure. It should be noted herein that a person of ordinary skill in the art may further make improvements without departing from the creative concept of the present disclosure, but these all fall within the protection scope of the present disclosure.

What is claimed is:

1. A lens module, comprising a lens barrel, a lens group disposed in the lens barrel, and a pressing ring,
the lens barrel comprising a first barrel wall provided with an optical aperture and a second barrel wall bending and extending from the first barrel wall, the second barrel wall comprising an inner-side wall near an optical axis and an outer-side wall disposed opposite to the inner-side wall,
the lens group comprises at least one lens,
wherein
the lens comprises an optical portion and a bearing portion disposed around the optical portion,
the bearing portion comprises an object side facing a side of an object, an image side disposed opposite to the object side, and a lateral surface connecting the object side and the image side,
the lens is provided with a first concave part concaved from the image side to the object side and runs through the lateral surface, the first concave part and the inner-side wall of the second barrel wall jointly form a first adhesive accommodating slot for accommodating adhesive,
the pressing ring comprises a first surface abutting against the image side and a second surface disposed opposite to the first surface, and the pressing ring is provided with a second concave part concaved from the second surface to the first surface, the second concave part and the inner-side wall of the second barrel wall jointly form a second adhesive accommodating slot for accommodating adhesive.

2. The lens module according to the claim 1, wherein the first adhesive accommodating slot is a continuous annular structure.

3. The lens module according to the claim 1, wherein the second adhesive accommodating slot is a continuous annular structure.

4. The lens module according to the claim 1, wherein the inner-side wall comprises a first abutting surface abutting against the lens group, an extend surface bending and extending from the first abutting surface to a direction away from the optical axis, and a second abutting surface bending and extending from the extend surface to a direction away from the first barrel wall,
the lateral surface abuts against the first abutting surface, and the pressing ring is fixed to the second abutting surface.

5. The lens module according to the claim 1, wherein the lens module further comprises a light-shielding member bonded to the lens.

6. The lens module according to the claim 5, wherein the light-shielding member is a hollow annular structure.
